(19) United States
(12) Patent Application Publication
(10) Pub. No.: US 2023/0084483 A1
(43) Pub. Date: Mar. 16, 2023

(54) PATTERN RECONFIGURABLE UHF RFID READER ANTENNA ARRAY

(71) Applicant: Drexel University, Philadelphia, PA (US)

(72) Inventors: Md Abu Saleh Tajin, Philadelphia, PA (US); Kapil R. Dandekar, Philadelphia, PA (US)

(73) Assignee: Drexel University, Philadelphia, PA (US)

(21) Appl. No.: 17/823,976

(22) Filed: Sep. 1, 2022

Related U.S. Application Data
(60) Provisional application No. 63/239,464, filed on Sep. 1, 2021.

(51) Int. Cl. G06K 7/10; H01Q 1/22; H01Q 9/04; H01Q 21/24

(52) U.S. Cl. CPC G06K 7/10316; H01Q 1/2216; H01Q 9/0428; H01Q 21/24

(57) ABSTRACT

The growing research interest in passive RFID (Radio Frequency Identification)-based devices and sensors in a diverse group of applications calls for flexibility in reader antenna performance. A low-cost, easy-to-fabricate, and pattern reconfigurable UHF (Ultra High Frequency) RFID reader antenna in the RFID ISM band (902-928 MHz in the US) may offer a 54 MHz bandwidth (890 944 MHz) and 8.9 dBi maximum gain. The reconfigurable antenna can radiate four electronically switchable radiation beams in the azimuth plane. The antenna may be LHCP (Left Hand Circularly Polarized) with axial ratio (AR) in the ranging from 0.45 dB to 7 dB in the RFID ISM band.

### STATEMENT REGARDING GOVERNMENT SUPPORT

This invention was made with government support under Contract No. CNS-1816387 awarded by the National Science Foundation. The government has certain rights in the invention.

### BACKGROUND

Radio Frequency Identification (RFID) systems are increasingly in demand for a diverse set of applications. As the prevalence of these systems increases, the demand for flexible reader antennas is growing. A reader/interrogator antenna is an integral part of an RFID system. A reader antenna capable of electronically and dynamically steering radiation beams towards a specified direction would be valuable addition not only for warehouse inventory monitoring but also for smart healthcare and household applications. Modern passive RFID tags have lower sensitivity that enables them to operate at very low power levels. As a result, LOS (Line-Of-Sight) communication is not required in most scenarios. A passive RFID tag can be activated even by multipath components. Reconfigurable antennas have been proven to be an effective means for interference management in wireless networks. In a similar fashion, a reconfigurable RFID reader antenna would increase the coverage area of an RFID system and help monitor the passive tag/sensor even when the user is moving.

RFID reader antennas have high gain and high front-to-back ratio in their radiation pattern. As a result, the tags placed behind the antenna suffer from almost no coverage. The major requirements of RFID reader antennas include impedance match in the band of interest (902-928 MHz in the United States), high gain, and circular polarization. High gain is important for covering larger areas. Since the majority of passive RFID tags are linearly polarized, there is a 3 dB path loss between the reader (circularly polarized) and the tag antenna (linearly polarized) due to polarization mismatch. In general, the maximum gain of an RFID reader antenna is preferred to be higher than 6 dBi for commercial applications. Higher gain also helps mitigate the adverse effects of multipath fading and reduce mutual interference between multiple readers. However, the higher gain also increases the need for the RFID reader to align its directive beam pattern with the tags that are to be tracked. According to FCC (Federal Communications Commission) regulations, the maximum EIRP (Effective Isotropically Radiated Power) by an RFID reader antenna must not exceed 36 dBm. In other words, the summation of the input power and maximum antenna gain should remain below 36 dBm.

Frequency, radiation pattern, and polarization are the features most explored in reconfigurable antenna applications. Some solutions present a frequency reconfigurable reader antenna that covers the UHF (Ultra High Frequency) RFID band at 915 MHz and the WLAN (Wireless Local Area Network) band at 2.4 GHz. Further, the number of UHF passive RFID tag-based on-body sensors is growing rapidly. Passive RFID tags do not have a local power source/battery. The tags are wirelessly energized by the external reader/interrogator antenna. Human body parts have large relative permittivity and wearable antennas greatly lose radiation efficiency in the proximity of the body. Consequently, on-body tag antennas in general have a low read range. The movement of the user poses an additional challenge to the sensor system. As a result, an RFID reader equipped with dynamic radiating beams will be a valuable addition to new on-body passive RFID sensor research.

Some solutions propose a reconfigurable (polarization and radiation pattern) reader antenna array system that can switch between two antenna elements. The system is primarily designed for handheld mobile devices. Both of the proposed designs restrict the maximum number of antenna elements to two. As a result, their method cannot cover the entire azimuth plane. Other solutions show beamforming techniques using antenna arrays.

Sector array antennas with multiple unidirectional beams at sub-6 GHz frequencies are common. However, none of these designs have been proposed for UHF RFID reader applications. Additionally, a self-reconfigurable RFID reader antenna is a good candidate for smart RFID reader applications.

### SUMMARY OF THE EMBODIMENTS

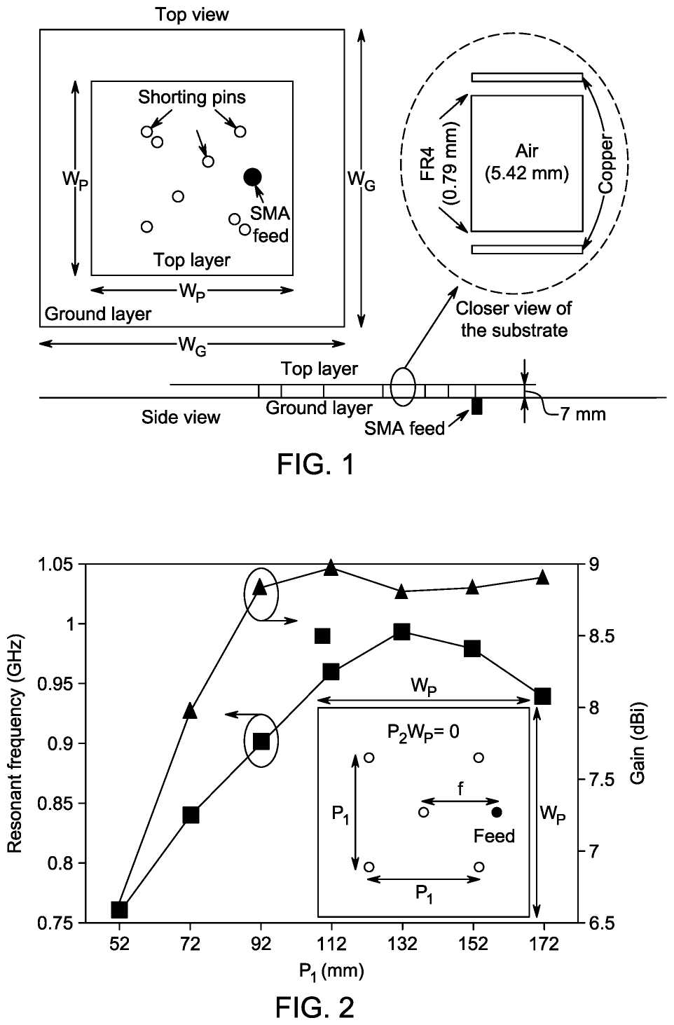

A new reconfigurable UHF RFID reader antenna design addresses some of the above problems and constraints. The antenna array includes four identical antenna elements (FIG. 1). Some of the features of the new reader antenna design include i.) good impedance match in the 902-928 MHz UHF RFID band, ii.) high gain with electrically reconfigurable beam patterns to find and track tags in dynamic environments and cover the entire azimuthal plane, specifically increasing read range in challenging on-body RFID scenarios, iii.) circularly polarized design to not only communicate with linearly polarized tags, but also enable good performance in non-line of sight RFID situations, and iv.) low cost due to the use of FR4 boards instead of RT Duroid with a design that can be fabricated quickly.

### BRIEF DESCRIPTION OF THE EMBODIMENTS

FIG. 1 shows top and side views of an array element in the reconfigurable reader antenna: WG=305 mm, WP=178 mm.

FIG. 2 shows sweep of P1. The feeding point is 60 mm apart from the center of the patch.

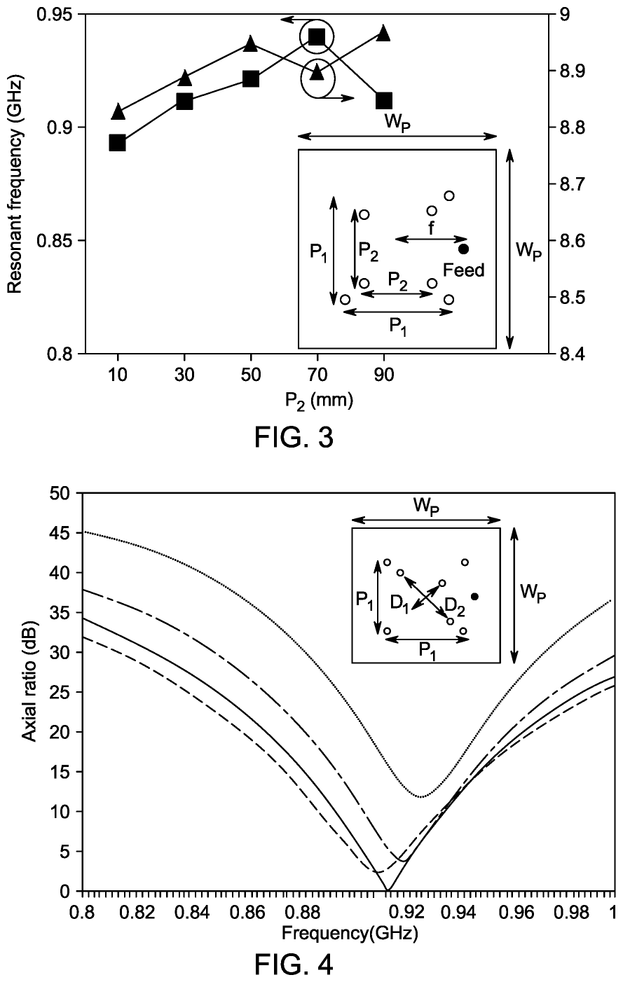

FIG. 3 shows sweep of P2 variable. P1 remains fixed at 92 mm.

FIG. 4 shows a final pin configuration and the sweep of the D1 parameter. D1=41 mm provides the best axial ratio performance around 915 MHz.

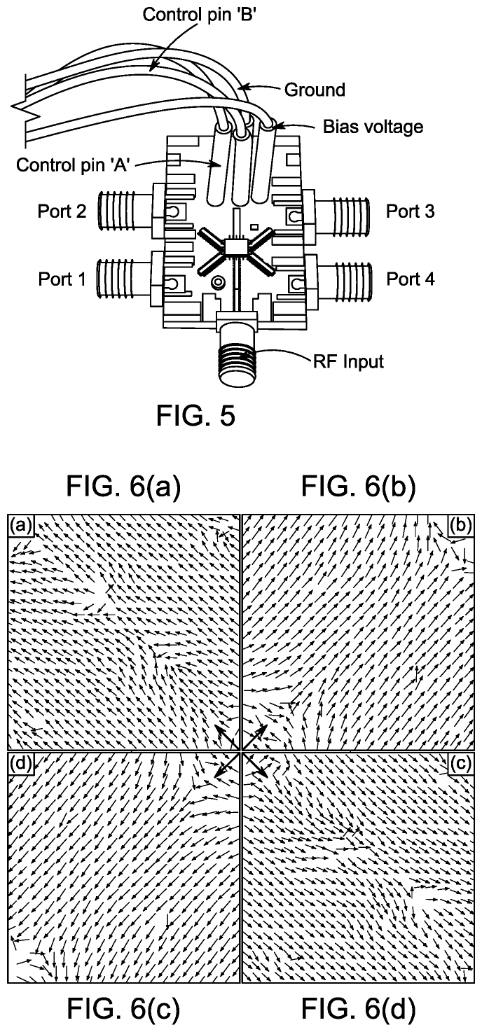

FIG. 5 shows a SP4T RF switch.

FIGS. 6(a)-6(d) show a surface current density vector field on the central portion (bottom view) of the top patch. FIG. 6(a) shows t=0, FIG. 6(b) shows t=T/4, FIG. 6(c) shows t=T/2, FIG. 6(d) shows t=3T/4 (‘T’ is the period of the current wave). The dark arrows show the general direction of the surface current.

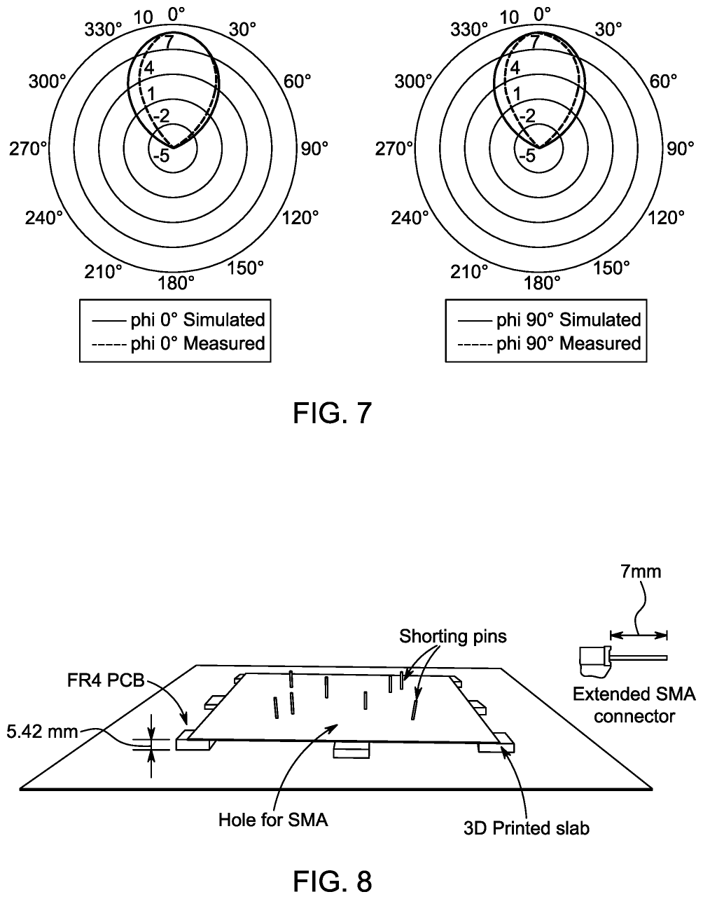

FIG. 7 shows simulated and measured radiation patterns of the reader antenna. The radii of the plot indicate gain in dBi.

FIG. 8 shows a single antenna during fabrication.

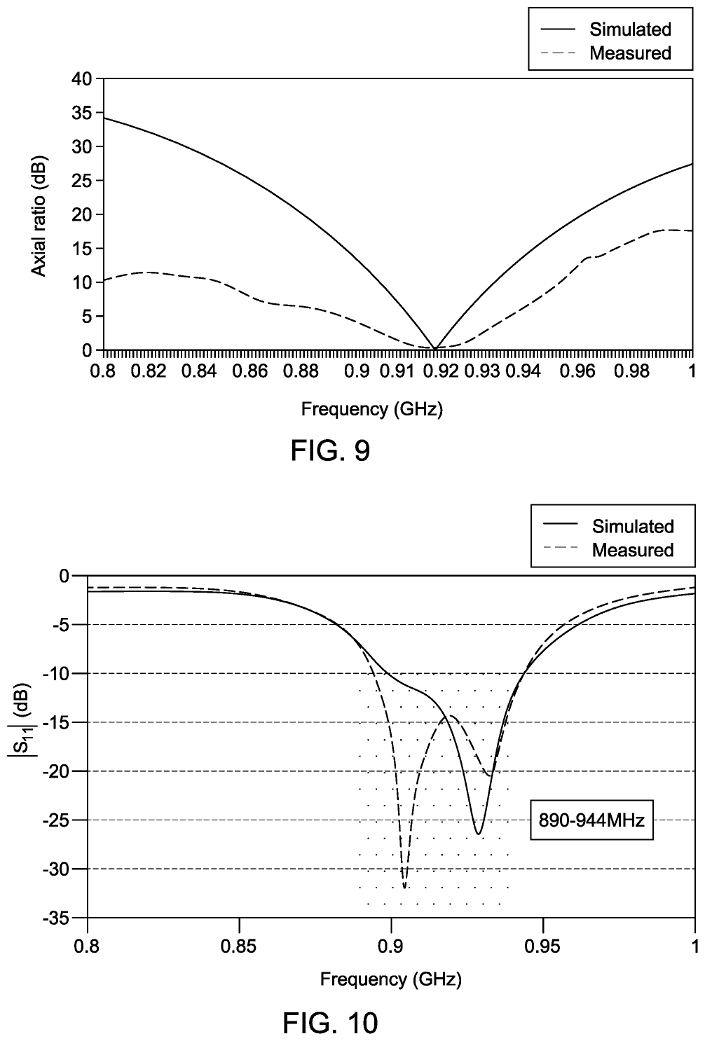

FIG. 9 shows simulated and measured axial ratio (dB) as a function of frequency. Axial ratio values are simulated and measured along the θ=0, phi=0 direction.

FIG. 10 shows |S11| of a single reader antenna. The 10 dB bandwidth covers from 890 MHz to 944 MHz.

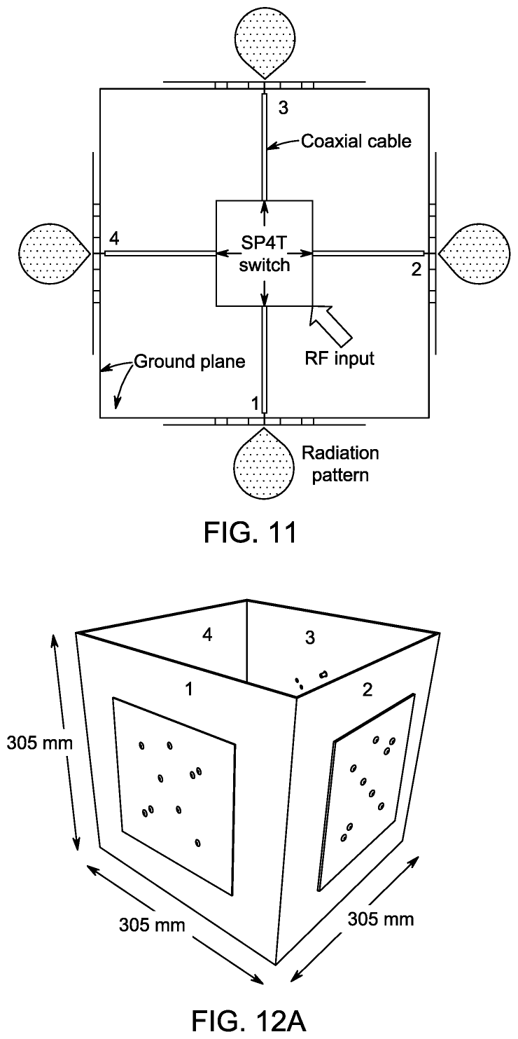

FIG. 11 shows a top view of the reconfigurable reader antenna system. Based on the position of the user, an optimum radiating beam can be initiated. In this figure, antenna-4 is radiating, while the other three antennas are inactive.

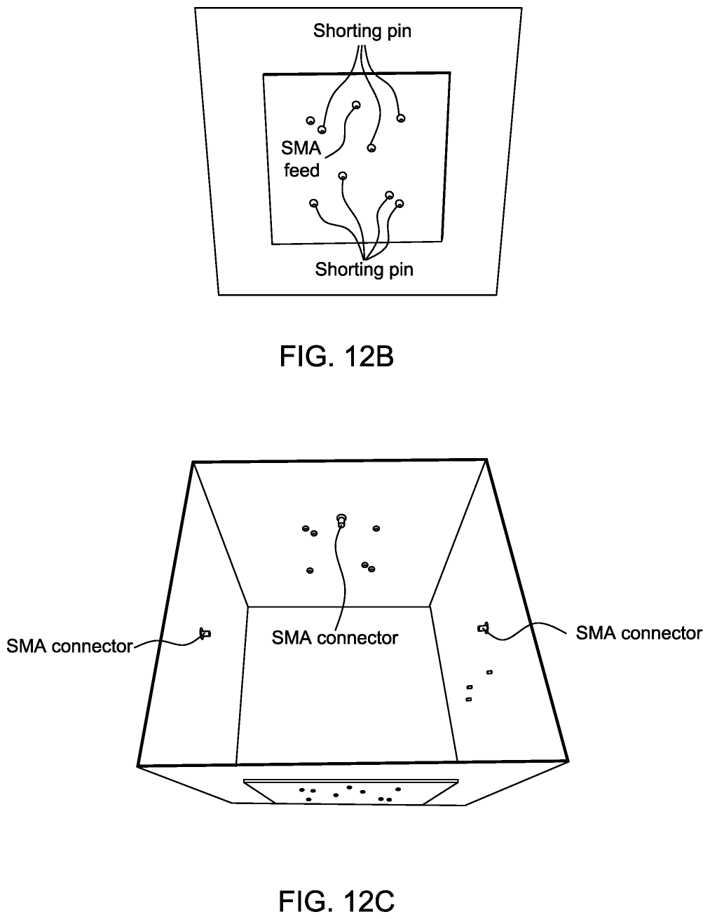

FIGS. 12A-C show an different views of the reconfigurable reader antenna.

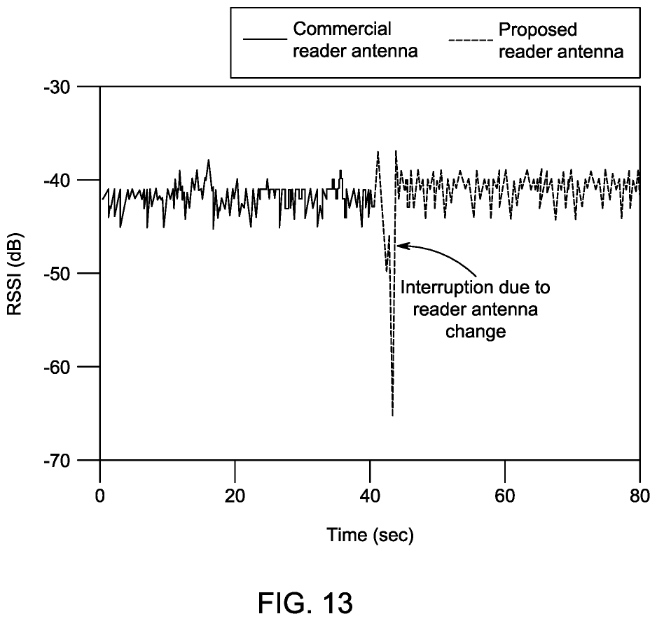

FIG. 13 shows a comparison of interrogation performance of single reader element against a commercially available reader antenna.

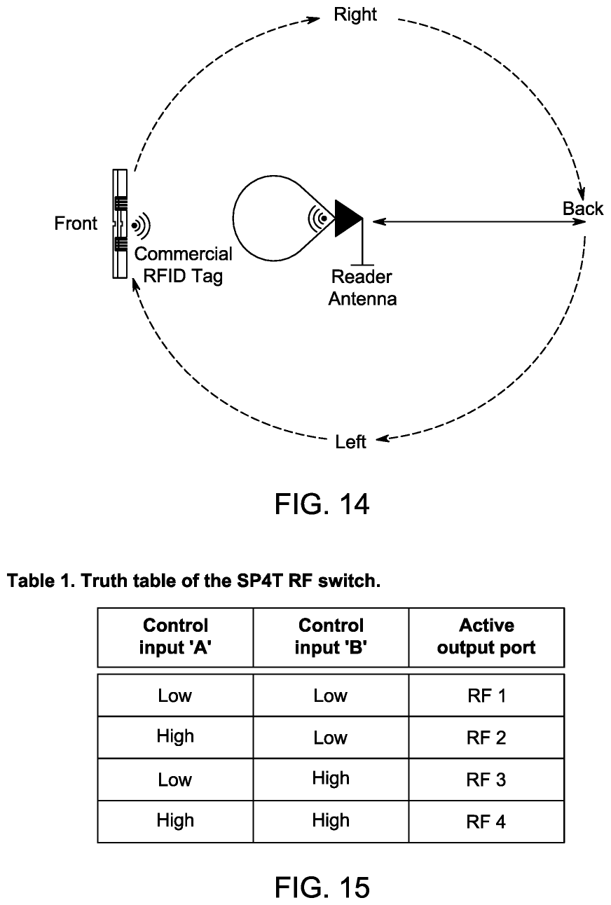

FIG. 14 shows an experimental setup for testing the coverage areas of reader antennas.

FIG. 15 shows Table 1.

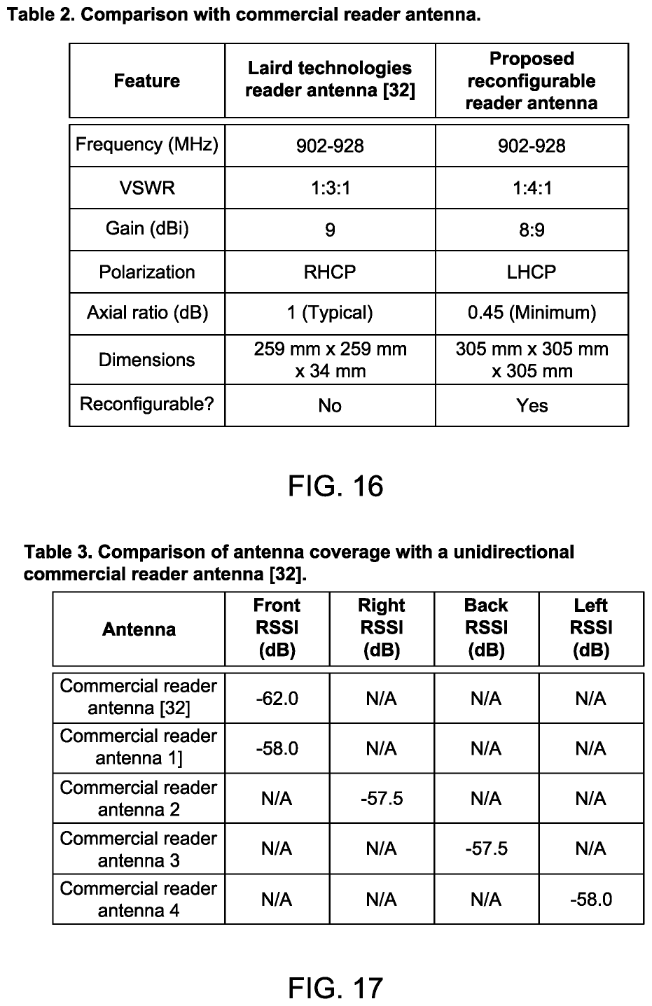

FIG. 16 shows Table 2.

FIG. 17 shows Table 3.

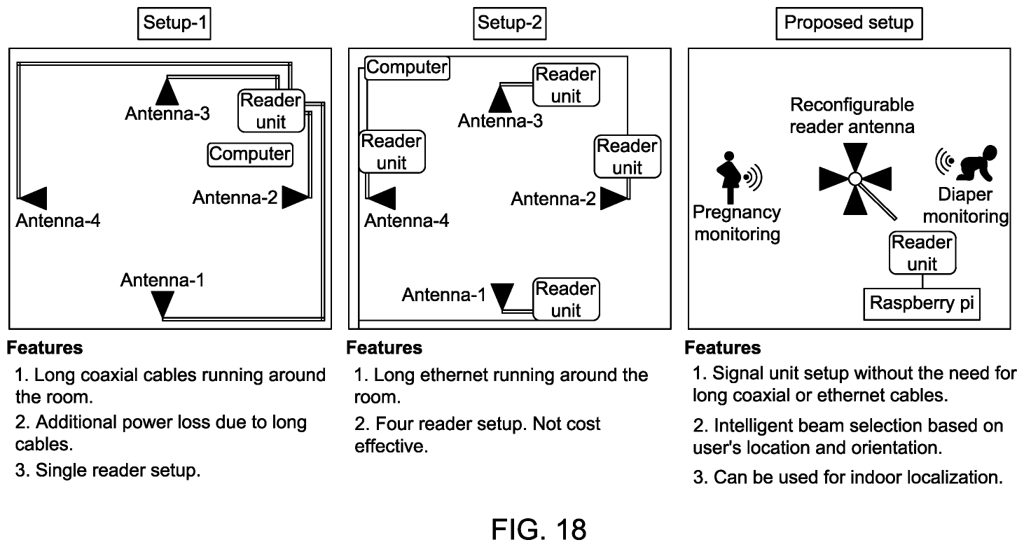

FIG. 18 shows two prior art setups compared to the proposed setup.

### DETAILED DESCRIPTION OF THE EMBODIMENTS

### I. Antenna Design, Simulation and Fabrication

The reconfigurable reader antenna may comprise four identical patch antennas 1, 2, 3, and 4 shown in FIGS. 11 and 12 and described in the next section. The antenna array elements may be arranged in a square formation and the ground plane of the antenna array element is glued to the ground planes of two adjacent elements. A common RF feed may be connected to the input port of a commercially available RF SP4T (Single-Pole, Four-Throw) switch (FIG. 5). The SMA ports of the unit antennas (4 in total) are separately connected to the four SMA output ports of the switch. Only one antenna element is activated at a time, based on the configuration of two DC control inputs (A and B) in the RF switch. FIG. 15, Table 1 shows the truth table of the SP4T RF switch. The insertion loss and return loss of the switch are very low, and the isolation between output ports is very high in the frequency range 0.1 6 GHz. FIGS. 12A-12C show the reconfigurable reader antenna. The SP4T switch and the control circuits may be housed inside the free space of the reconfigurable reader antenna structure.

RFID tag antennas may be placed at the producer or user end while the reader antenna is placed in free space, where the tag antenna may be miniaturized in size. Additionally, the tag may be able to communicate with the reader antenna independent of the tag's physical orientation. If both antennas are linearly polarized, the read performance is dominated by the alignment between the electric fields of the reader and tag antennas. In other words, matched polarization (0° angle between the electric fields of the tag and reader antennas) would result in better RSSI, and mismatched polarization (90° angle between the electric fields of the tag and reader antennas) may result in zero received power. If both the reader and tag antenna polarization is circular, it is mandatory to maintain similar rotation (both either RHCP (Right Hand Circularly Polarized) or LHCP (Left Hand Circularly Polarized)). Otherwise, there will not be any communication (in an anechoic environment) due to the theoretically infinite polarization loss factor. Even if the polarization rotation is matched, a rotational mismatch occurs once any of the main beams is reflected because the polarization reverts once reflected off a surface.

In other words, RHCP becomes LHCP after reflection and vice versa. This limits one of the advantages of RFID systems being able to communicate with multipath components instead of line-of-sight components. On the other hand, a circular-linear antenna pair would incur a constant 3 dB path loss due to polarization mismatch. In most cases, the commercially available tag antennas are linearly polarized, and the reader antenna is circularly polarized. Although circularly polarized tag antennas have been proposed for various applications, they are larger and heavier compared to commercial tags. The proposed antenna polarization is LHCP. RHCP configuration is possible by mirroring the shorting pins.

A. Single Antenna Array Element Design

Substrate materials with higher relative permittivity (e.g. FR4, Er=4.4) help with antenna miniaturization, but at the cost of reduced antenna radiation efficiency. Since high gain performance is expected for RFID reader applications, the substrate height needs to be relatively large (7 mm in the proposed design). FR4 boards at this thickness are not common, and the final antenna structure would be heavier with customized 7 mm FR4 boards. On the other hand, substrates at the lower end of the relative permittivity scale (e.g. Rogers 5880, Er 2.2) may be good for radiation efficiency, but the antenna size will increase. Thicker substrates also introduce surface waves. As a result, the effect of increased radiation efficiency is countered by the unwanted surface waves. To alleviate the situation mentioned above, the inventors use two thin, one-sided FR4 boards of 0.79 mm thickness (FIG. 8). The two layers may be separated by 5.4 mm of air. The shorting pins (nine in total) not only dictate the current distribution in the two conductive layers but also provide enough mechanical support to hold the two layers 7 mm apart. As a result, the antenna substrate is a three-layered sandwich comprising FR4-air-FR4. The relative permittivity of air is very low (Er=1). As a result, the electric fields are loosely bound inside the antenna structure. This configuration helps reduce power loss inside the substrate and increase power in the radiated space waves.

The antenna is probe fed with a modified SMA (Sub-Miniature version A) connector (FIG. 8). The intended operating band of the proposed antenna is 902-928 MHz. The free-space wavelength (λ0) at 915 MHz is 328 mm. The length of rectangular microstrip patch antennas usually remain between the range λ0/3<L<λ0/2. The inventors chose 178 mm length (0.5 λ0) for the proposed square patch (FIG. 2) and began the simulation with a shorting pin at the center of the patch. Four more pins are placed diagonally and equidistant from the center ((2P1)\hat{ }1/2). The separation between two adjacent pins is (P1). The feeding probe is 60 mm away from the center of the patch. The position of the probe gives an additional degree of freedom during the impedance matching in the desired frequency band. The inventors ran a parameter sweep (P1) in HFSS (High Frequency Structure Simulator) from 52 mm to 172 mm at 10 mm equal steps. The purpose of the sweep is to find an optimum value of P1 so that the antenna gain is high and the resonant frequency is fairly close to the operating band (902-928 MHz). FIG. 2 shows that antenna gain is maximum (8.91 dBi) at P1=172 mm. However, the resonant frequency is 940 MHz. In the next round of parameter sweep, the resonant frequency would increase. As a result, the inventors chose an optimum point where the gain is fairly large and the resonant frequency is lower than 915 MHz. For P1=92 mm, the antenna gain is 8.84 dBi and the resonant frequency is 902 MHz. This is the optimum value for P1.

The inventors removed the center pin and place four additional pins in the same fashion as the previous ones. However, the second set of pins were closer to the center of the patch. The separation between two adjacent pins is P2. The feeding probe is not moved at this stage (f 60 mm). The P2 variable is varied from 10 mm to 90 mm at 10 mm equal steps (FIG. 3). The third stage of simulation is run to achieve circular polarization in the frequency band (902-928 MHz). In other words, the axial ratio of the antenna may need to be low (ideally 0 dB) for achieving circular polarization. We observe that the third stage of simulation reduces the resonant frequency. So the inventors chose P2=70 mm. The antenna gain is 8.9 dBi, and the resonant frequency is 950 MHz.

FIGS. 2 and 3 shows symmetric structures where two orthogonal dominant modes are generated at the same resonant frequency. For achieving circular polarization, these two dominant modes may be split in a way that they have equal amplitudes and their phase difference is 90° in the resonant frequency. This way, the surface current direction will be circularly rotating, leading to circular polarization. The inventors keep one pair of diagonal inner pins (D2 in FIG. 4) at its place and move the other diagonal inner pins (D1 in FIG. 4) towards each other and vary the D1 parameter in HFSS from 12.7 mm to 55.2 mm. The axial ratio vs frequency plot (FIG. 4) shows that the best axial ratio performance is achieved at D1 41 mm. In FIG. 6, we plot the surface current density vector fields on the central portion (bottom view) of the patch at four different instances in a single period (T) at 915 MHz. Electric fields are parallel to the surface current density vector. Since the surface current density vector rotates as a function of time, the radiated electric field vectors follow the rotation.

Depending on the choice of static diagonal pair of pins (D2 in this case), the polarization becomes RHCP or LHCP.

B. Radiation Pattern, S11, and Axial Ratio

In FIG. 3, the antenna structure is symmetric about two axes. Once the diagonal pins came closer (FIG. 4), the antenna is now symmetric about a single axis. The two orthogonal dominant modes are split, leading to a larger bandwidth and lower axial ratio within the band. FIG. 10 shows the simulated and measured reflection coefficient (S11) of the antenna. Two dips observed in the S11 plot are caused by the split in the orthogonal dominant modes. Measured S11 shows that −10 dB pass-band of the antenna ranges from 890 MHz to 944 MHz. The 54 MHz bandwidth is enough to cover the UHF RFID band (902 928 MHz) in the US.

Axial ratio is a measure of the quality of circular polarization. FIG. 9 shows the simulated and measured axial ratio vs frequency plots of the reader antenna in the UHF ISM band.

FIG. 7 depicts the simulated and measured gain pattern of the reader antenna along the elevation angle (θ). The maximum gain of the antenna is 8.9 dBi. The front-to-back ratio is 23 dB.

C. Antenna Fabrication

The fabrication of the proposed antenna is fast and simple. FIG. 8 shows the antenna under construction. The steps for the fabrication are as follows:

1) Two single-sided 0.79 mm thick FR4 sheets are first used. The top and bottom layers are cut out of these two, and via holes are created using drill bits.

2) A few 5.42 mm thick rectangular plastic slabs are fabricated using a 3D printer. The purpose of these slabs is to help maintain uniform distance (5.42 mm) between the top and bottom layers.

3) Commercially available metal paper clips are clipped and used as shorting pins (1 mm diameter). Pins are inserted in the corresponding holes while the top and bottom layers are separated by the plastic slabs.

4) The pins are soldered on both top and bottom sides, with protruding ends clipped off (FIG. 12A).

5) An SMA connector port (see FIG. 12C) without an extended center pin is taken and a 7 mm long steel pin is soldered to the center of the connector. The extended connector is then inserted to the feed-hole (FIG. 12B) and soldered onto both layers of the antenna.

### II. Comparison with Commercial Reader

FIG. 16, Table 2 compares the proposed reconfigurable reader antenna with a commercially available reader antenna.

A. Interrogation Performance

The inventors used a commercially available UHF RFID reader antenna to compare the reading performance with a proposed single antenna. A Speedway R420 reader is used to drive both antennas at a 28 dBm power level in an open lab environment. The commercial reader antenna gain is 9 dBi, and we assume 1 dB cable and connector loss. The maximum Effective Isotropically Radiated Power (EIRP) is 36 dBm, which remains within the maximum limit imposed by the Federal Communications Commission (FCC). A commercial UHF RFID tag is first interrogated by the commercial reader from a fixed distance. The RSSI is recorded, and the reader antenna is carefully replaced by a proposed reader antenna. The two sets of RSSI are plotted in FIG. 13. There is a 1 dB difference between the mean RSSI obtained by the proposed reconfigurable antenna and the commercial reader antenna. The mismatch in RSSI can be attributed to the difference between antenna gain, unmatched cable losses, and a small difference in path loss due to the uncertainty in antenna phase centers.

B. Coverage in Azimuth Plane

Commercially available RFID reader antennas are high-gain, unidirectional, and circularly polarized antennas. The proposed reconfigurable RFID reader antenna not only offers the features available in a commercial reader antenna but also provides a wider coverage area in the azimuth plane. To compare the coverage performance of the proposed antenna with a commercial antenna, the inventors placed a commercial RFID tag 2.4 m away from the reader antenna (FIG. 14). When the tag is within the main radiation beam of the commercial reader antenna, the position is called ‘Front.’ The tag is placed at three more positions equidistant from the reader antenna. These positions are ‘Right’, ‘Back’, and ‘Left.’ The reader antenna is driven with a Speedway R420 reader at 28 dBm input power level. The experiment is repeated four more times with one of the unit reader antennas activated at a time. FIG. 17, Table 3 shows that the commercial reader antenna only interrogates the tag when the tag is in front of it. The tag remains out of monitoring in the right, back, and left positions. On the other hand, with the proposed reconfigurable reader antenna, the tag is always successfully interrogated by one of the antenna elements/units.

FIG. 18 shows a comparison of two prior art setups vs. the reconfigurable setup in use. In Setup-1, there are four antennas connected by long runs of coaxial cable. This results in long cable runs and power loss, as well as other advantages. In Setup-2, ethernet runs circle the run, which is also not cost effective. The proposed setup, in contrast, using the reconfigurable array in the center of the room avoids the long runs and multiple antenna mounting points.

### III. Conclusion

This presents the design and fabrication procedures of a new UHF RFID reader antenna in the 902-928 MHz ISM band. The antenna was simulated in HFSS and corresponding measurements are presented to validate the simulation. The system forms a reconfigurable reader antenna array using four unit antennas, capable of radiating four independent radiation beams in the azimuth plane. Depending on the position of the RFID tags, an optimum radiating beam may be activated by selecting the best antenna element. The proposed reconfigurable reader antenna system offers flexibility and an increased coverage area for passive RFID-based applications.

A comparison with a commercially available unidirectional reader antenna shows that the proposed reconfigurable reader antenna offers similar features necessary for RFID reader applications. Moreover, the proposed reader antenna provides better coverage in the azimuth plane. The limitation of the proposed antenna is that each antenna element of the array is capable of producing a single radiation beam. As a result, the entire reader antenna can generate four directional beams. Producing multi-directional beams with a single antenna element is not easy. Moreover, the restrictions of maintaining good bandwidth, high gain, and circular polarization makes it very challenging.

The system may automate the reconfigurable reader antenna state (active element) selection using machine learning techniques. The RSSI received from the user tags may be used as the decision metric. Additionally, learning-based beam activation techniques for interference alignment with multiple beam reconfigurable RFID reader antennas may share common coverage areas.

The proposed reconfigurable RFID reader antenna can potentially be used for RFID-based indoor localization applications. Current methods suggest deploying four individual reader antennas on four corners of the room or the use of a rotary table at the center of the room. Using the antenna herein may remove the need for such long wiring or moving parts.

While the invention has been described with reference to the embodiments herein, a person of ordinary skill in the art would understand that various changes or modifications may be made thereto without departing from the scope of the claims.

1. A reconfigurable reader antenna comprising:
four identical patch antennas that form an antenna array;
a radio frequency (RF) feed connected to an input port of a single-pole, four-throw switch, wherein the switch comprises at least four SubMiniature version A (SMA) ports and the SMA ports are connected to each of the antennas.

2. The reconfigurable reader antenna of claim 1, wherein each of the antennas comprise at least two FR4 sheets connected by shorting pins, with a layer of air between the sheets.

3. The reconfigurable reader antenna of claim 2, wherein each of the SMA ports are connected to each of the FR4 sheets.

4. The reconfigurable reader antenna of claim 3, wherein the antennas each form a side of an open cube.

5. The reconfigurable reader antenna of claim 1, wherein each antenna has a high gain, covers ISM band, and is circularly polarized.

6. The reconfigurable reader antenna of claim 1, further comprising a controller that controls signals of the RF switch.

7. The reconfigurable reader antenna of claim 6, wherein an interrogating signal to the RF switch is diverted to an appropriate one of the antennas depending on a control signal combination.

8. The reconfigurable reader antenna of claim 7, wherein a machine learning algorithm is used to select an appropriate antenna based on RSSI (Received Signal Strength Indicator) data.

9. The reconfigurable reader antenna of claim 1, wherein an operating band of the reconfigurable reader antenna is 902-928 MHz.

10. The reconfigurable reader antenna of claim 1, wherein a length of the antennas is between a range λ0/3<L<λ0/2.
